(19) United States
(12) Patent Application Publication
(10) Pub. No.: US 2020/0289942 A1
(43) Pub. Date: Sep. 17, 2020

(54) PRODUCING A MATCH FOR A MULTIPLAYER SESSION

(71) Applicant: Microsoft Technology Licensing, LLC, Redmond, WA (US)

(72) Inventor: Thomas P. MINKA, Cambridge (GB)

(21) Appl. No.: 16/351,128

(22) Filed: Mar. 12, 2019

(51) Int. Cl. A63F 13/798; A63F 13/795; A63F 13/335; A63F 13/358

(52) U.S. Cl. CPC A63F 13/798; A63F 13/358; A63F 13/335; A63F 13/795

(57) ABSTRACT

Described herein are techniques for transforming skill ratings for players from one skill rating space (e.g., established according to a model such as TRUESKILL) to another skill rating space. The techniques determine a function that is useable to transform a skill rating in a first skill rating space into a transformed skill rating in a second skill rating space. The function that is useable to transform a skill rating defines an acceptance region associated with the transformed skill rating. The techniques can then use the transformed skill rating and the acceptance region to match a player with other players. A utility function can be used to evaluate different transformation functions and identify an optimal transformation function useable to match players.

### BACKGROUND

A multiplayer game enables players to compete against other players either individually or in a team setting. In many cases, a multiplayer game is played online (e.g., using network connections to establish a multiplayer game session). An important aspect to hosting a multiplayer game session is the ability for a game title, or a studio, to match players based on skill. To do this, a matchmaking system is implemented to receive matchmaking requests from players and to produce matches. A matchmaking request includes a skill rating for a player. The skill rating can be used to match the player with other players that have similar skill ratings in order to enhance the gaming experience and to help ensure a fair and a competitive gaming environment based on skill.

Many conventional matchmaking systems produce matches by comparing a skill rating gap (e.g., a difference between a skill rating of a first player and a skill rating of a second player) to a skill rating gap threshold. The skill rating gap threshold is typically set manually by a person. In some cases, the threshold varies automatically according to the length of time a matchmaking request has waited to be matched, but the initial threshold and its rate of increase are still set manually by a person. Moreover, different skill gap rating thresholds are typically needed for different skill rating groupings determined from a skill rating distribution. While a smaller skill rating gap threshold improves the likelihood of a fair and a competitive gaming environment, a smaller skill rating gap threshold often requires players to wait longer to be matched. In contrast, a larger skill rating gap threshold reduces the likelihood of a fair and a competitive gaming environment, but a larger skill rating gap threshold allows players to be matched in a more efficient manner (e.g., less waiting).

Consequently, by varying the skill rating gap threshold, a matchmaking system can achieve different average wait times and average skill rating gaps for the matches it produces. However, there is an unavoidable trade-off between the average wait time and the average skill rating gap. Conventional matchmaking systems have been unable to find a policy that finds an optimal trade-off between these two metrics, as well as other metrics. In other words, conventional matchmaking systems have been unable to find the right balance between the average wait time and the average skill rating gap, as well as other metrics, so that the player community is receiving the best possible matchmaking experience at all times.

### SUMMARY

This disclosure describes a matchmaking system (may be referred to below as a system) that transforms skill ratings for players from one skill rating space (e.g., established according to a model such as TRUESKILL) to another skill rating space. In particular, the techniques described herein determine a function that is useable to transform a skill rating, in a first skill rating space, into a transformed skill rating in a second skill rating space. The techniques can then use the transformed skill rating in the second skill rating space to match a player with other players, or produce a match. This function may be referred to herein as a transformation function.

The system described herein is configured to receive matchmaking requests from players of a game title that want to be matched with other players. In various examples described herein, these matchmaking requests can be referred to as tickets. A matchmaking request includes a player identification (e.g., a name, a player tag, etc.), a skill rating established according to a model (e.g., TRUESKILL), and a time when the matchmaking request is received by the system (may be referred to herein as a “creation time” of a matchmaking request). A matchmaking request can also include other types of information (e.g., a requested game mode, a latency table, etc.) that may be used by the system to produce matches. Upon reception, the system places the matchmaking request in a matchmaking queue and the matchmaking request waits to be matched. A match output by the system includes a set of matchmaking requests (e.g., two or more matched matchmaking requests) and a time when the match is output (may be referred to as a “creation time” of a match). Once a matchmaking request is matched, the matchmaking request is removed from the matchmaking queue by the system.

As further described herein, application of the transformation function to a skill rating included in a matchmaking request defines an acceptance region. An acceptance region represents possible skill ratings (e.g., a range of skill ratings), included in other matchmaking requests, that the matchmaking request will accept in a match output by the system. The acceptance region defined by a transformation function is an interval of fixed width in the second skill rating space, centered on the transformed skill rating of the matchmaking request. By using the transformation function to define an acceptance region, the approach used by conventional matchmaking systems that requires a person to monitor and tune skill rating gap thresholds for different skill rating groupings in an attempt to optimize the match making is no longer needed.

The system can use a utility function to evaluate different transformation functions and identify an optimal transformation function useable to match matchmaking requests. The utility function outputs a value based on a combination of metrics used by a matchmaking system. The combination of metrics accounts for a trade-off between the average wait time, the average skill rating gap, and/or other metrics. Stated another way, the utility function can be used to evaluate how well a matchmaking system produces matches based on observed metrics and/or expected metrics, as further described herein.

In various examples, the utility function is a linear function that includes different metrics determined over a large set of matches. Example metrics can include a “wait time” metric, a “skill rating gap” metric, and/or a “win rate difference” metric. Other metrics can be included as well. The wait time metric can be set to the average length of time between the creation time of a matchmaking request and the creation time of a match for the matchmaking request. For matchmaking, the ideal wait time is zero, meaning players are matched immediately thereby improving the experience because no waiting is involved. The skill rating gap metric can be set to an average distance between a skill rating of a first player and a skill rating of a second player in a match. For matchmaking, the ideal skill rating gap is zero, meaning matched players effectively have the same skill thereby improving the experience by producing a fair and a competitive gaming environment. The “win rate difference” metric can be set to an average, over skill ratings, of the absolute difference between fifty percent and an expected win rate of a player with a particular skill rating. The expected win rate can be calculated as a proportion of matches that a player with that skill rating is likely to win, due to the player's skill rating being higher than an opponent's skill rating. For matchmaking, the ideal win rate is fifty percent, meaning each player wins half the games played and loses half the games played.

In some examples described herein, the skill rating gap metric may be represented in terms of a “predictability” of the match outcome (e.g., a winner) given the skill rating gap between players. The predictability is a nonlinear function of the skill rating gap. For instance, the predictability of the match outcome for two players with the same skill rating is fifty percent. Thus, reference may be made herein to a “predictability” metric.

The utility function includes weights associated with individual metrics. The weights can be set by a game title to increase and/or decrease the influence of a particular metric in accordance with a preference. Since the utility function drives the optimization of the transformation function used to make matches, the preferences of a game title are reflected in the matches produced by the system.

Because the utility function prefers matches with a smaller skill rating gap, the acceptance region of a matchmaking request can be a continuous interval in the transformed skill rating space. That is, if a matchmaking request that includes a skill rating S is willing to match with another matchmaking request that includes a skill rating T, then the matchmaking request must also be willing to match with a matchmaking request that has a skill rating between T and S. Consequently, an acceptance region of a matchmaking request can be represented by two numbers, e.g., L (left) and R (right), such that the matchmaking request accepts a match when the other matchmaking request has a skill rating between the two numbers (e.g., greater than L and less than R).

In various examples, a reciprocity constraint can be applied to an acceptance region. The reciprocity constraint is based on a realization that, given that two matchmaking requests both have to accept to make a match, it does not make sense to configure a region of one matchmaking request to accept another matchmaking request that will not reciprocate the acceptance. Therefore, the reciprocity constraint limits the acceptance region of a matchmaking request to ensure that another matchmaking request with a skill rating within the acceptance region always accepts a match. Using reciprocity, there exists a transformation f such that f (S))=f (S)−1 and f (R(S))=f (S)+1. In other words, an acceptance region is a fixed interval with a threshold distance of one in a transformed skill rating space.

Reciprocity makes it possible to compute the expected utility of any proposed acceptance region. Because the utility function is linear, the expected utility of any proposed acceptance region is a linear function of the expected value of each metric used in the utility function. However, the wait time metric in the utility function depends on a matchmaking request arrival rate and a skill rating distribution of the match searching player population. Moreover, the predictability metric and the win rate difference metric depend on the skill rating distribution of the match searching player population.

Accordingly, the system described herein is configured to determine both an estimated matchmaking request arrival rate and an estimated skill rating distribution for time intervals (e.g., predetermined time intervals such as each hour of the day, each three hour period of the day, each day of the week, etc.). The system can determine these estimates by monitoring a match searching player population to determine actual matchmaking request arrival rates and/or skill rating distributions for the time intervals. In some examples, the system can use machine learning to “learn” the estimates for the time intervals based on historical data related to player matching.

To compute an expected wait time, the system determines a probability that a random skill rating lands in an acceptance region (referred to herein as “ProbInRegion”). This probability is the area of the estimated skill rating distribution between L and R of the acceptance region. Moreover, the system determines a probability that an acceptable matchmaking request will be closest to this matchmaking request (referred to herein as “ProbClosest”). The probability that a random matchmaking request matches is therefore prob=ProbInRegion * ProbClosest. If matchmaking requests are estimated to arrive at a rate (“rate”), then matching requests arrive at a rate determined by rate*prob. In a produced match, one matchmaking request arrives first and waits, while the other matchmaking request does not have to wait at all. Therefore, the expected wait time for the matchmaking request is 1/(rate*prob) and the expected wait time for the second matchmaking request is zero. Consequently, the overall expected wait time for the acceptance region is 0.5/(rate*prob).

To compute the expected predictability of a match between a matchmaking request with a skill rating S and an accepted matchmaking request with a skill rating between L and R of an acceptance region, the system divides the estimated skill rating distribution between L and R into slices of equal probability. The expected predictability is an unweighted average across the slices. Then the system bounds the predictability in each slice. For example, a trivial upper bound is max(predictability(S,sliceL),predictability(S,sliceR)) since predictability is highest at the boundary. The system then takes an unweighted average of the upper bounds across the slices, to get an upper bound on the expected predictability, and similarly to get a lower bound on the expected predictability. The system can then take the average of the upper and the lower bounds to determine the expected predictability. In some instances, the difference between the upper and the lower bounds provides an approximation error which can be used to tune the number of slices.

The expected win rate difference is determined using an expected win rate. Computing the expected win rate of a matchmaking request with a skill rating S when matched with an accepted matchmaking request with a skill rating between L and R of an acceptance region can be done in a similar manner. The system divides the estimated skill rating distribution between L and R into slices of equal probability. The expected win rate is an unweighted average across the slices. Then the system bounds the win rate in each slice. For example, a trivial upper bound is max(winrate(S,sliceL),winrate(S,sliceR)) since win rate is highest at the boundary. The system then takes an unweighted average of the upper bounds across the slices, to get an upper bound on the expected win rate, and similarly to get a lower bound on the expected win rate. The system can then take the average of the upper and the lower bounds to determine the expected win rate. In some instances, the difference between the upper and the lower bounds provides an approximation error which can be used to tune the number of slices.

The utility function can be used to evaluate, or score, different transformation functions based on the expected wait time, the expected predictability, and the expected win rate difference of the resulting acceptance regions. The evaluation yields a transformation function f that maximizes expected utility over all matchmaking requests that are likely to be received. In one example, a “Branch and Bound” search is used to determine the most optimal transformation function f, though alternative optimization functions can be used as well.

The system is further configured to update the expected wait time, the expected predictability, and the expected win rate difference over a period of time when the estimated matchmaking request arrival rate and/or the estimated skill rating distribution change. This changes the optimal transformation function for the matchmaking requests waiting in the queue to be matched. In some implementations, the system can re-compute expected metrics based on the updated estimated matchmaking request arrival rate and/or the updated estimated skill rating distribution. In some implementations, the system can use expected metrics that have been learned. That is, the system can monitor a match searching player population and determine actual matching metrics for particular time intervals (e.g., a particular hour of a particular day) and use the actual matching metrics as expected metrics for similar time intervals in the future.

In further implementations, a matchmaking request can have additional properties, other than a skill rating, which can be used to produce matches. These additional properties enable multiple different matchmaking request types, as further described herein. For example, a type of a matchmaking request can be defined by a game mode and/or a geographic region which represents latency.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a matchmaking system is configured to use transformed skill ratings to match players for a multiplayer session.

FIG. 2 is a diagram illustrating an example of how a utility function can be used to determine a transformation function that converts skill ratings included in matchmaking requests from a first skill rating space into a second skill rating space.

FIG. 3 is a flow diagram of an example method for transforming a skill rating received in a matchmaking request into a transformed skill rating, and using the transformed skill rating to produce a match for a multiplayer session.

FIG. 4 illustrates an example matchmaking request with additional properties which allows for multiple different types.

FIG. 5 is a computer architecture diagram illustrating an illustrative computer hardware and software architecture for a computing system capable of implementing aspects of the techniques and technologies presented herein.

### DETAILED DESCRIPTION

Described herein are techniques for transforming skill ratings for players from one skill rating space (e.g., established according to a model such as TRUESKILL) to another skill rating space. The techniques determine a function that is useable to transform a skill rating in a first skill rating space into a transformed skill rating in a second skill rating space. The function that is useable to transform a skill rating defines an acceptance region associated with the transformed skill rating. The techniques can then use the transformed skill rating and the acceptance region to match a player with other players. A utility function can be used to evaluate different transformation functions and identify an optimal transformation function useable to match players.

By using a transformation function to define an acceptance region, the approach used by conventional matchmaking systems that requires a person to monitor and tune skill rating gap thresholds for different skill rating groupings in an attempt to optimize the match making is no longer needed.

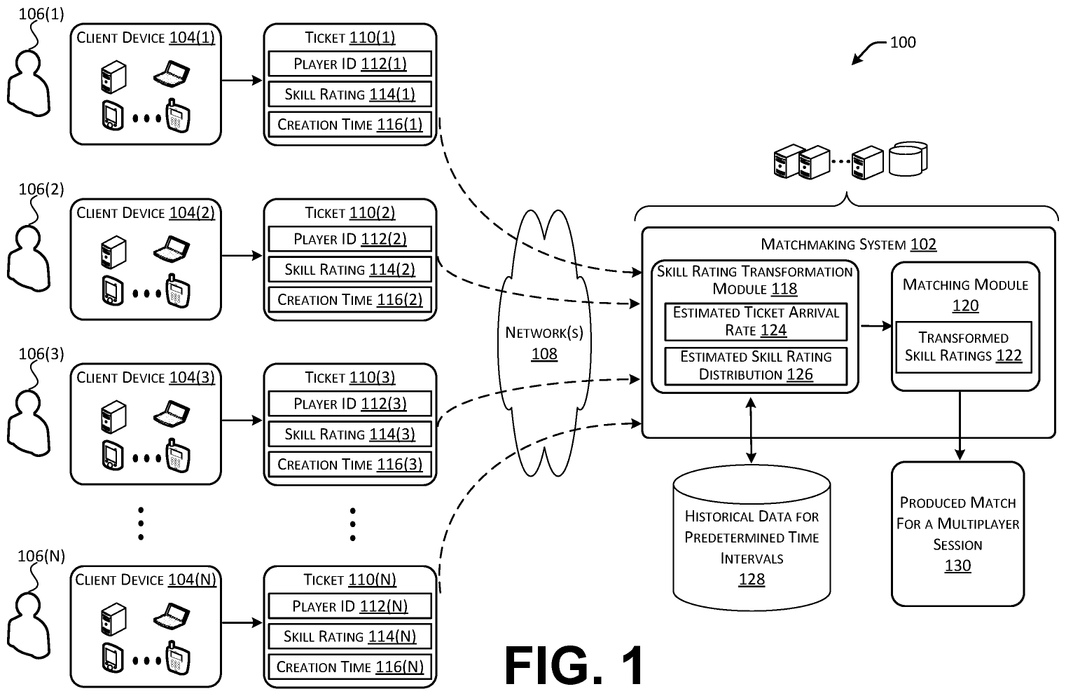

Various examples, scenarios, and aspects that effectively match players based on transformed skill ratings are described below with reference to FIGS. 1-5.

FIG. 1 is a diagram illustrating an example environment 100 in which a matchmaking system 102 is configured to use transformed skill ratings to match players for a multiplayer session. FIG. 1 illustrates various client devices 104(1)-104(N) (may be referred to herein as client devices 104) associated with different players 106(1)-106(N) (may be referred to herein as players 106) that are requesting to be matched for a particular game title during a period of time (where N in the context of FIG. 1 is a positive integer number that can be hundreds, thousands, hundreds of thousands, etc. players wanting to be matched).

The client devices 104 enable players to participate, individually or as part of a team, in a multiplayer session. The multiplayer session can be hosted, over network(s) 108, by a gaming system (e.g., PLAYSTATION NOW, NINTENDO NETWORK, XBOX LIVE, etc.). That is, a gaming system can provide a multiplayer session service enabling players 106 to participate in multiplayer sessions. In one configuration, the gaming system may be operated by a game title. The matchmaking system 102 can be part of the gaming system configured to host a multiplayer session. Alternatively, the matchmaking system 102 can be a separate system that can be called upon by a gaming system to produce a match for a multiplayer session to be hosted by the gaming system. In an alternative implementation, a multiplayer session can be hosted by the client devices 104 using peer-to-peer communications. This alternative implementation is more likely to be used for multiplayer sessions that include two players.

A multiplayer session can be provided and/or hosted by resources (e.g., program code executable to generate game content, devices such as a server, networking functionality, etc.) developed and/or operated by a game title . Thus, the game title can comprise resources related developing, publishing, and/or hosting a multiplayer session, for example. A participant in a multiplayer session can comprise an individual player of the multiplayer session, or alternatively, a participant can comprise a team of players in the multiplayer session (e.g., a team can have two or more players).

When the players 106 want to be matched, the client devices 104 are each configured to generate and send matchmaking requests to the matchmaking system 102. In examples provided herein, these matchmaking requests can be referred to as tickets. Accordingly, FIG. 1 illustrates that the client devices 104 generate and send tickets 110(1)-110(N) (may be referred to herein as tickets 110), and the tickets 110 are received by the matchmaking system 102. The tickets 110 include player identifications 112(1)-112(N) (e.g., a name, a player tag, etc.), skill ratings 114(1)-114(N) established in first skill rating space (e.g., a TRUESKILL rating), and creation times 116(1)-116(N) that reflect when the tickets 110 are received by the matchmaking system 102. The tickets 110 can also include other types of information. For example, the tickets 110 can include a requested game mode or a geographic region that reflects an amount of latency associated with a location of a session hosting server. Upon reception, the matchmaking system 102 places the tickets 110 in a matchmaking queue and the tickets 110 wait to be matched.

The matchmaking system 102 can comprise device(s) (e.g., servers) and/or other components that communicate with one another, with a gaming system, and/or with the client devices 104 via one or more network(s) 108. Moreover, the matchmaking system 102 can include a skill rating transformation module 118 and a matching module 120. The skill rating transformation module 118 is configured to transform the skill ratings 114 in a first skill rating space, which are included in the tickets 110, into transformed skill ratings 122 in a second skill rating space that can be used by the matching module 120. As further described herein, the transformation is based on an estimated ticket arrival rate 124 and an estimated skill rating distribution 126 of a match searching player population.

The number of illustrated modules is just an example, and the number can vary higher or lower. That is, functionality described herein in association with the illustrated modules can be performed by a fewer number of modules or a larger number of modules on one device or spread across multiple devices.

The estimated ticket arrival rate 124 and the estimated skill rating distribution 126 can be determined using historical data established for predetermined time intervals 128 (e.g., each hour of the day, each three hour period of the day, each day of the week, etc.). For instance, the skill rating transformation module 118 can be configured to determine these estimates by monitoring a match searching player population to determine actual ticket arrival rates and/or skill rating distribution for the predetermined time intervals. In some examples, the skill rating transformation module 118 can use machine learning to “learn” the estimates for the predetermined time intervals based on the historical data. Machine learning techniques that may be utilized can include: unsupervised learning, semi-supervised learning, classification analysis, regression analysis, clustering, etc. One or more predictive models may also be utilized, such as a group method of data handling, Naive Bayes, k-nearest neighbor algorithm, majority classifier, support vector machines, random forests, boosted trees, Classification and Regression Trees (CART), neural networks, ordinary least square, and so on.

The matching module 120 is then configured to match players using the transformed skill ratings 122. Once two or more players are matched, the matching module 120 outputs a produced match 130 so a multiplayer session can be established and the matched players can begin to play a game. Consequently, a produced match output by the matchmaking system 102 includes a set of tickets (e.g., two or more matched tickets) and a time when the match is output (i.e., a “creation time” of a match). Once a ticket is matched, the ticket is removed from the matchmaking queue by the matchmaking system 102.

In various implementations, the skill rating transformation module 118 is configured to update the transformation based on updated estimates. Since the match searching player population varies from one predetermined time interval to the next (e.g., one hour of the day to the next hour, one three hour period to the next three hour period, one day to the next day, etc.), the ticket arrival rate and/or the skill rating distribution changes. As further described herein, the updated estimates can be used to optimize the transformation so that more effective matchmaking is performed by the matchmaking system 102.

Network(s) 108 can include, for example, public networks such as the Internet, private networks such as an institutional and/or personal intranet, or some combination of private and public networks. Network(s) 108 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 108 can utilize communications protocols, including packet-based and/or datagram-based protocols such as internet protocol (IP), transmission control protocol (TCP), user datagram protocol (UDP), or other types of protocols. Moreover, network(s) 108 can also include a number of devices that facilitate network communications and/or form a hardware basis for the networks, such as switches, routers, gateways, access points, firewalls, base stations, repeaters, backbone devices, and the like.

In various examples, device(s) of a matchmaking system 102 can include one or more computing devices that operate in a cluster or other grouped configuration to share resources, balance load, increase performance, provide fail-over support or redundancy, or for other purposes. For instance, device(s) of a matchmaking system 102 can belong to a variety of classes of devices such as traditional server-type devices.

A client device (e.g., one of client devices 104) can belong to a variety of classes of devices, such as server-type devices, desktop computer-type devices, mobile-type devices, special purpose-type devices, embedded-type devices, and/or wearable-type devices. Thus, a client device can include, but is not limited to, a desktop computer, a game console and/or a gaming device, a tablet computer, a personal data assistant (PDA), a mobile phone/tablet hybrid, a laptop computer, a telecommunication device, a wearable device, a virtual reality (VR) device, an augmented reality (AR) device, an automotive computer, a network-enabled television, a terminal, an Internet of Things (IoT) device, a work station, a media player, a personal video recorders (PVR), a set-top box, or any other sort of computing device.

A client device can include input/output (I/O) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like). A client device can also include one or more network interface(s) to enable communications between device(s) over network(s) 108. Such network interface(s) can include one or more network interface controllers (NICs) or other types of transceiver devices to send and receive communications and/or data over a network.

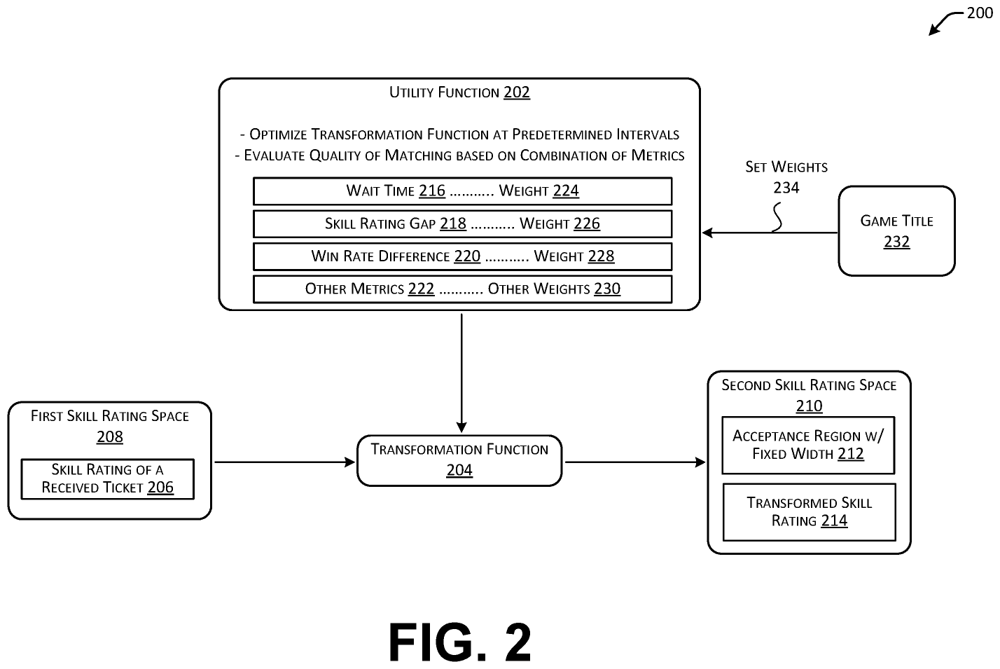

FIG. 2 is a diagram 200 illustrating an example of how a utility function 202 can be used to determine a transformation function 204 that converts a skill rating of a received ticket 206 from a first skill rating space 208 into a second skill rating space 210. As described above, the transformation function 204 defines an acceptance region 212 with an interval of fixed width in the second skill rating space 210. The acceptance region 212 is centered on the transformed skill rating 214. The acceptance region 212 represents possible skill ratings (e.g., a range of skill ratings), included in other tickets, that a ticket will accept to produce a match. By using the transformation function 204 to define an acceptance region 212, the approach used by conventional matchmaking systems that requires a person to monitor and tune skill rating gap thresholds for different skill rating groupings in an attempt to optimize the match making is no longer needed.

The utility function 202 is configured to evaluate different transformation functions and identify an optimal transformation function (e.g., transformation function 204) useable to match tickets. The utility function 202 outputs a value based on a combination of metrics used by the matchmaking system 102. The value can be used to evaluate the quality of matching based on the combination of metrics. Stated another way, the utility function 202 can be used to evaluate how well a matchmaking system produces matches based on observed metrics and/or expected metrics.

In various examples, the utility function 202 is a linear function that includes different metrics. Example metrics can include a wait time metric 216, a skill rating gap metric 218, and/or a win rate difference metric 220. Other metrics 222 can be included as well. The wait time metric 216 can be set to the average length of time between the creation time of a ticket and the creation time of a match for the ticket. The skill rating gap metric 218 can be set to an average distance between a skill rating of a first player and a skill rating of a second player in a match. The win rate difference metric 220 can be set to an average, over skill ratings, of the absolute difference between fifty percent and an expected win rate of a player with a particular skill rating. The expected win rate can be calculated as a proportion of matches that a player with that skill rating is likely to win, due to the player's skill rating being higher than an opponent's skill rating.

The skill rating gap metric may be represented in terms of a “predictability” of the match outcome (e.g., a winner) given the skill rating gap between players. The predictability is a nonlinear function of the skill rating gap. For instance, the predictability of the match outcome for two players with the same skill rating is fifty percent. Thus, reference may be made herein to a predictability metric.

In one example, the utility function 202 can be defined as follows in equation (1):

Utility (WaitTime, Predictability, WinRateDifference)=−WaitTime−PredictabilityWeight*Predictability*100—WinWeight*WinRateDifference*100

As shown, the utility function 202 can include weights 224, 226, 228, 230 associated with individual metrics. In some instances, not all metrics include a weight. The weights can be set by a game title 232 to increase and/or decrease the influence of a particular metric in accordance with a preference, as referenced by 234. Since the utility function 202 drives the optimization of the transformation function 204 used to make matches, the preference of the game title 232 will be reflected in the matches that are produced. In the example utility function 202 provided above, the WinRateDifference=|WinRate −0.5|. The PredictabilityWeight represents an amount of time a game title is willing to make players wait to lower Predictability by one percentage point, and WinWeight represents an amount of time the game title is willing to make players wait to lower WinRateDifference by one percentage point. For instance, if predictability Weight is two, then one extra percentage point of predictability is worth two seconds of waiting.

Because the utility function 202 prefers matches with a smaller skill rating gap, the acceptance region 212 of a ticket can be a continuous interval in the transformed skill rating space (i.e., the second skill rating space 210). That is, if a ticket that includes a skill rating S is willing to match with another ticket that includes a skill rating T, then the ticket must also be willing to match with a ticket that has a skill rating between T and S. Consequently, an acceptance region 212 of a ticket can be represented by two numbers, e.g., L (left) and R (right), such that the ticket accepts a match when the other ticket has a skill rating between the two numbers (e.g., greater than L and less than R).

In various examples, a reciprocity constraint can be applied to an acceptance region 212. The reciprocity constraint is based on a realization that, given that two tickets both have to accept to make a match, it does not make sense to configure a region of one ticket to accept another ticket that will not reciprocate the acceptance. Therefore, the reciprocity constraint limits the acceptance region 212 of a ticket to ensure that another ticket with a skill rating within the acceptance region will always accept a match. Using reciprocity, there exists a transformation f as follows in equation (2):

f(L(S))=f (S) −1 and f (R (S))=f (S)+1.

In other words, an acceptance region is a fixed interval with a threshold distance of one in a transformed skill rating space. A theorem that supports reciprocity is as follows:

If L and R are functions with the following properties:
1. L(S)<S<R(S)
2. For any T between L(S) and S inclusive, R(T)≥S (reciprocation on the left).
3. For any T between S and R(S) inclusive, L(T)≤S (reciprocation on the right).

Then L and R must have the following form, for some function f:
4. L(S)=f⁻¹(f (S) −1)
5. R(S)=f⁻¹(f (S)+1)
Proof:
First, it can be shown that L must be a non-decreasing function. Suppose that T<S. If T<L(S) then L(T)<L(S). Otherwise, T is between L(S) and S, and therefore between L(S) and R(L(S)) (since R(L(S))≥S by property 2) so by property 3, L(T)≤L(S).
Similarly, R must be a non-decreasing function. Suppose that T>S. If T>R(S) then R(T)>R(S). Otherwise, T is between L(R(S)) and R(S) inclusive, so by property 2, R(T)≥R(S).
Substitute S→L(S) and T=R(L(S)) in property 3 to get L(R(L(S)))≤L(S).
Suppose the gradient of L at S is non-zero. Since L is non-decreasing, this implies R(L(S))≤S. Combined with property 2, this implies R (L(S))=S. In other words, L and R are inverse functions at points with non-zero gradient. Let S* be any point where the gradient of L is non-zero. Since L is non-decreasing, S>S* implies L(S)≥L(S*). Therefore, when L is repeatedly applied to any S>S*, a value in the interval [L(S*)S*] will eventually be reached. Let g be any increasing function that maps the interval [L (S*), S*] to [−1,0]. For any S>S*, f is computed by repeatedly applying L until a value T is reached in the interval [L(S*), S*]. If L was applied k times, then f (S)=g(T)+k. Since R is non-decreasing, S<L(S*) implies R(S)≤R(L(S*))=S*. For any S<L(S*), f is computed by repeatedly applying R until a value T in the interval [L(S*), S*] is reached. If R is applied k times, then f (S)=g(T)−k. Such an f satisfies properties 4 and 5.

Accordingly, reciprocity makes it possible to compute the expected utility of any proposed acceptance region. Because the utility function 202 is linear, the expected utility of any proposed acceptance region is a linear function of the expected value of each metric used in the utility function. However, the wait time metric in the utility function depends on a ticket arrival rate and a skill rating distribution of the match searching player population. Moreover, the predictability metric and the win rate difference metric depend on the skill rating distribution of the match searching player population.

To compute an expected wait time 216, the skill rating transformation module 118 determines a probability that a random skill rating lands in an acceptance region (referred to herein as “ProbInRegion”). This probability is the area of the estimated skill rating distribution between L and R of the acceptance region. Moreover, the skill rating transformation module 118 determines a probability that an acceptable ticket will be closest to this ticket (referred to herein as “ProbClosest”). The probability that a random ticket matches is therefore prob=ProbInRegion*ProbClosest. If tickets are estimated to arrive at a rate (“rate”), then matching tickets arrive at a rate determined by rate*prob. In a produced match, one ticket arrives first and waits, while the other ticket does not have to wait at all. Therefore, the expected wait time for the first ticket is 1/(rate*prob) and the expected wait time for the second ticket is zero. Consequently, the overall expected wait time 216 for the acceptance region is 0.5/(rate*prob).

A formula to determine “ProbClosest” can be implemented as follows. Suppose a ticket with skill rating U is waiting for a ticket in the range [L,R]. There could be another waiting ticket with skill rating T. A new ticket with skill rating S would be stolen by this other waiting ticket whenever (T-S)<(S-U), i.e., S>(T+U)/2. So the probability of being stolen is the probability that another waiting ticket has skill rating T<2S−U. If the ticket arrival rate is V and the average wait time is W, then the queue has an average of V*W waiting tickets. Let the actual number of waiting tickets (e.g., a random integer) be N in this scenario. If the probability of drawing a skill in the “stolen” range is P, then the probability of being the closest ticket is (1-P)^{N-1}. This depends on S, so the system computes an integral over the acceptance region, as well as an expectation over N. Since N can be distributed according to a Poisson, the expectation over N is exp(−E[N-1]P), which depends on the average wait time.

To compute the expected skill rating gap 218 (e.g., the expected predictability) of a match between a ticket with a skill rating S and an accepted ticket with a skill rating between L and R of an acceptance region, the skill rating transformation module 118 divides the estimated skill rating distribution between L and R into slices of equal probability. The expected predictability is an unweighted average across the slices. Then the skill rating transformation module 118 bounds the predictability in each slice. For example, a trivial upper bound is max(predictability(S,sliceL),predictability(S,sliceR)) since predictability is highest at the boundary. The skill rating transformation module 118 then takes an unweighted average of the upper bounds across the slices, to get an upper bound on the expected predictability, and similarly to get a lower bound on the expected predictability. The skill rating transformation module 118 can then take the average of the upper and the lower bounds to determine the expected predictability. In some instances, the difference between the upper and the lower bounds provides an approximation error which can be used to tune the number of slices.

The expected win rate difference 220 is determined using an expected win rate. Computing the expected win rate of a ticket with a skill rating S when matched with an accepted ticket with a skill rating between L and R of an acceptance region can be done in a similar manner as computing the expected skill rating gap. The skill rating transformation module 118 divides the estimated skill rating distribution between L and R into slices of equal probability. The expected win rate is an unweighted average across the slices. Then the skill rating transformation module 118 bounds the win rate in each slice. For example, a trivial upper bound is max(winrate(S,sliceL),winrate(S,sliceR)) since win rate is highest at the boundary. The skill rating transformation module 118 then takes an unweighted average of the upper bounds across the slices, to get an upper bound on the expected win rate, and similarly to get a lower bound on the expected win rate. The skill rating transformation module 118 can then take the average of the upper and the lower bounds to determine the expected win rate. In some instances, the difference between the upper and the lower bounds provides an approximation error which can be used to tune the number of slices.

By specifying the combination of metrics, the utility function 202 can be used to evaluate, or score, different transformation functions based on the expected wait time 216, the expected skill rating gap 218 (e.g., expected predictability), and the expected win rate difference 220 of the resulting acceptance regions. The evaluation yields a transformation function f 204 that maximizes expected utility over all matchmaking requests that are likely to be received. In one example, a “Branch and Bound” search is used to determine the most optimal transformation function f 204, though alternative optimization functions can be used as well.

For example, the skill rating transformation module 118 can determine an optimal transformation function f 204 using a cumulative distribution function of the estimated skill rating distribution. The cumulative distribution function is a smooth curve with a value of zero on the left, a value of one on the right, and a median skill rating is 0.5. For a given skill rating of a ticket, the skill rating transformation module 118 evaluates the cumulative distribution function by determining the fraction of the skill distribution that is less than the skill rating. The skill rating transformation module 118 can then scale the cumulative distribution function according to various scale values and perform a one-dimensional search over the possible scaling numbers, e.g., using a Branch and Bound search, to determine the optimal transformation function f 204 to be used by the matchmaking system 102 to produce matches.

A Branch and Bound search is an algorithm that optimizes an objective function J(x), where x is a vector ranging over some search space. The algorithm tiles the search space into disjoint rectangles and computes a cheap upper bound on the maximum utility achievable in each rectangle. The algorithm samples a random point x in the most promising rectangle (i.e., the one with highest upper bound) and compares J(x) with the best solution thus far. Then it splits that rectangle in half and repeats. Eventually it finds an x whose J(x) is higher than any upper bound, and therefore higher than any other point in the search space.

The skill rating transformation module 118 is configured to update the expected wait time, the expected predictability, and the expected win rate difference over a period of time when the estimated ticket arrival rate 124 and/or the estimated skill rating distribution 126 change. This changes the optimal transformation function 204 for the tickets waiting in the queue to be matched. In some implementations, the skill rating transformation module 118 can re-compute expected metrics based on the updated estimated ticket arrival rate 124 and/or the updated estimated skill rating distribution 216. In some implementations, the skill rating transformation module 118 can use expected metrics that have been learned, via machine learning, based on a historical data. That is, the skill rating transformation module 118 can monitor a match search player population and determine actual matching metrics for particular time intervals (e.g., a particular hour of a particular day) and use the actual matching metrics as expected metrics for similar time intervals in the future.

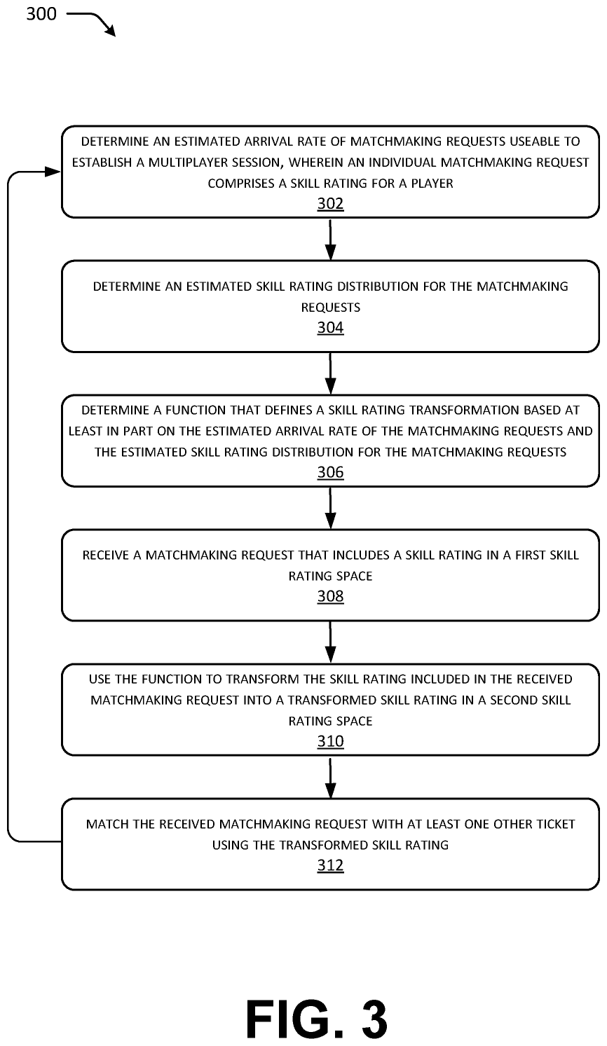

FIG. 3 represent an example process in accordance with various examples from the description of FIGS. 1 and 2. The example operations shown in FIG. 3 can be implemented on or otherwise embodied in one or more device(s) of the matchmaking system 102.

The order in which the operations are described is not intended to be construed as a limitation, and any number of the described operations can be combined in any order and/or in parallel to implement each process. Moreover, the operations in FIG. 3 can be implemented in hardware, software, and/or a combination thereof. In the context of software, the operations represent computer-executable instructions that, when executed by one or more processing units, cause one or more processing units to perform the recited operations. For example, modules and other components described herein can be stored in a computer-readable media and executed by at least one processing unit to perform the described operations.

FIG. 3 is a flow diagram of an example method 300 for transforming a skill rating received in a matchmaking request into a transformed skill rating, and using the transformed skill rating to produce a match for a multiplayer session.

At operation 302, an estimated arrival rate of matchmaking requests useable to establish a multiplayer session is determined. For example, the estimated arrival rate of matchmaking requests can be determined by monitoring a match searching player population to determine actual matchmaking request arrival rates for particular time intervals. Historical data can be stored based on the monitoring and can be retrieved to determine the estimated arrival rate of matchmaking requests for a predetermined time interval. In some examples, the estimated arrival rate of matchmaking requests can be learned, using machine learning.

At operation 304, an estimated skill rating distribution for the matchmaking requests is determined. Similar to the estimated arrival rate of matchmaking requests, the estimated skill rating distribution can be determined by monitoring a match searching player population to determine actual estimated skill rating distributions for particular time intervals. Historical data can be stored based on the monitoring and can be retrieved to determine the estimated skill rating distribution for a predetermined time interval. In some examples, the estimated skill rating distribution can be learned, using machine learning.

At operation 306, a function that defines a skill rating transformation is determined based at least in part on the estimated arrival rate of the matchmaking requests and the estimated skill rating distribution for the matchmaking requests. The function can be determined from a plurality of possible functions based on the description above with respect to FIG. 2.

At operation 308, a matchmaking request that includes a skill rating in a first skill rating space is received. For instance, this skill rating may be established using the TRUESKILL model.

At operation 310, the function is used to transform the skill rating included in the received matchmaking request into a transformed skill rating in a second skill rating space. As described above, the transformed skill rating is associated with an acceptance region which can be used to match the matchmaking request with another matchmaking request.

At operation 312, the received matchmaking request is matched with at least one other matchmaking request using the transformed skill rating.

In various examples, the process returns from operation 312 to operation 302 and the estimates can be updated based on a change from predetermined time interval to another predetermined time interval. A change in the estimates can cause a change in the transformation function used to match matchmaking requests and players. For example, the system can determine an optimal transformation function using a cumulative distribution function of the estimated skill rating distribution. As described above, the cumulative distribution function is a smooth curve with a value of zero on the left, a value of one on the right, and a median skill rating is 0.5. For a given skill rating of a matchmaking request, the system evaluates the cumulative distribution function by determining the fraction of the skill distribution that is less than the skill rating. The system can then scale the cumulative distribution function according to various scale values and perform a one-dimensional search over the possible scaling numbers, e.g., using a Branch and Bound search, to determine the optimal transformation function to be used by the system to produce matches. In some instances, the system applies the updated transformation function to matchmaking requests that are still waiting in the queue to be matched (e.g., matchmaking requests received before the transformation function is updated), as well as new matchmaking requests received.

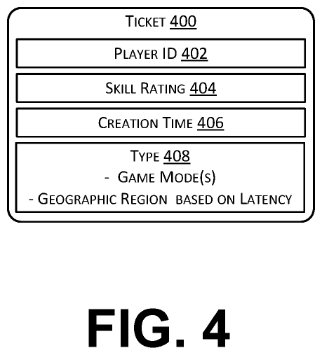

In further implementations, a ticket can have additional properties, other than a skill rating, which can be used to produce matches. These additional properties allow for multiple different ticket types. FIG. 4 illustrates an example ticket 400 with additional properties which allows for multiple different types. As shown, the ticket 400 includes the player identification 402, the skill rating 404, and the creation time 406, as described above with respect to FIG. 1. Further, the ticket includes additional information to define a type 408 of ticket. In various examples, a type 408 of ticket can be based on a game mode and/or a geographic region established based on latency. Different types of tickets can be established using other information, or properties, as well.

A game can include multiple game modes. For instance, different game modes may have different player objectives, different rules, and/or different conditions for declaring success (e.g., victory). In a war-type game, one game mode may define capturing territory as the main objective while another game mode may define an increased number of enemy kills as the main objective. A ticket received by the system may include a preferred game mode a players wants to play. Consequently, a skill rating transformation can occur based on a game mode specified in a ticket (e.g., a type of ticket). More specifically, an individual game mode can have its own estimates of a ticket arrival rate and skill rating distribution which are used to determine an optimal transformation as described above.

In some scenarios, a ticket may be one of two types, and a first of the two types may only be able to match with a second of the two types to produce match. For instance, a property may specify a side of a game a player prefers (e.g., a color for a chess game such as white or black, a side to attack for a sports a game such as left or right). Given these scenarios, there are two ticket types for a game (e.g., white and black, left and right, etc.) and a match can only be constructed between two tickets of different types (e.g., two players cannot both have black chess pieces, two opposing players cannot both attack the goal on the right side of the field, etc.). Each of these types can have its own estimates of a ticket arrival rate and a skill rating distribution. That is, if the two types of ticket arrive at different rates, then the waiting queue fills up faster with tickets of the more frequent type.

Accordingly, the acceptance region of a ticket depends on both a skill rating S and a specified type A or a specified type B. Let [L(S, A, B), R (S, A, B)] denote a range of skills on a ticket of type B that are acceptable to a ticket of type A and a skill rating S. This range must still satisfy reciprocity, which means if skill rating T falls between L(S,A,B) and R(S,A,B), then skill rating S falls between L(T,B,A) and R(T,B,A). A consequence is that L(L(S, A, B), B, A)≤S≤R (R (S, A, B), B, A). By the same reciprocity theorem provided above, there is a skill transformation f (S, A, B) such that:
L(L(S, A, B), B, A)=f⁻¹(f (S, A, B)−2, A, B)
R(R(S, A, B),B, A)=f⁻¹(f (S, A, B)+2, A, B)
   From this, the following can be determined:
L(S,A,B)=f⁻¹(f (S, A, B)−1,B,A)
R(S,A,B)=f⁻¹(f (S, A, B)+1,B,A)

Each ticket of the first type A has a skill transformation and each ticket of the second type B has a skill transformation, and the system tests whether the two transformed skills are within one. The system can work out the distribution of skill in the first type A and the distribution of skill in the second type B. Further, the system computes the cumulative transformation in order to transform a skill rating up to a learned scale factor for each type. For instance, f(S,A,B) can be approximated by a scaled version of the cumulative skill rating distribution of type A tickets. The scale factor depends on the statistics of type B tickets.

In additional scenarios, ticket types can be extended so that matches can be created not only between one type A ticket and one type B ticket, but also between one type A ticket and another type A ticket. Type B tickets still cannot match with each other. As described above, each ticket type has its own arrival rate and skill rating distribution.

To maximize utility, a type A ticket has two different acceptance regions: one defining the acceptable skill ratings of type A tickets and another defining the acceptable skill ratings of type B tickets. The first acceptance region can be [L(S, A, A), R (S, A, A)] and the second acceptance region can be [L(S, A, B), R(S, A, B)]. By reciprocity, there is a skill transformation f (S, A, A) such that:
L(S, A, A)=f⁻¹(f (S, A, A)−1, A, A)
R(S, A, A)=f⁻¹(f (S, A, A)+1, A, A)

Stated alternatively, there is a skill transformation of type A tickets such that two type A tickets match when the distance between the transformed skill ratings is less than or equal to one. When comparing a type A ticket with a type B ticket, a second transformation is used. A type B ticket uses a third transformation. Each of these transformations can be approximated by scaling the cumulative skill rating distribution for a corresponding type.

In these additional scenarios, the formula for expected wait time of a type A ticket must account for the two possible skill rating distributions it can match against. For a particular type A ticket, let prob(T) be the probability that a random type T ticket will match, for T=A or B. If type T tickets arrive at rate rate(T), then matching tickets arrive at rate rate(A)*prob(A)+rate (B)*prob(B). The expected wait time is therefore 0.5/(rate(A)*prob(A)+rate(B)*prob(B)).

To compute the expected predictability for a type A ticket, the expected predictability computed from the two skill rating distributions it can match against can be combined. For a particular type A ticket, let pred(T) be the expected predictability when matched against a type T ticket. The probability that the ticket will be matched with a type A ticket is weight(A)=(rateA*probA)/(rateA*probA+rateB*probB). Therefore the expected predictability is weight(A)*pred(A)+(1-weight(A))*pred(B).

Consequently, the expected utility depends on the acceptance regions between ticket type pairs that can match, and the optimal transformations are determined simultaneously.

In even further scenarios, consider N ticket types (N=3, 4, 5, 6, 7, and so forth) and they all of the N ticket types can match with each other. If there are N types, then each ticket has N different acceptance regions, depending on the ticket type it is being matched with. Each acceptance region corresponds to a threshold of one in a transformed skill space. Since there are N\hat{ }2 possible ordered type pairs, there are N\hat{ }2 skill transformations. Each transformation can be approximated by scaling the cumulative skill rating distribution, so in practice there are N\hat{ }2 scaling constants. If a match between two types is prohibited, then the acceptance region is empty and no constant needs to be stored. The system tracks the arrival rate and skill distribution of all N types to determine the transformations useable to match a type with every other type.

In a more specific example, the N types can be applied to game modes. Consider an implementation where each ticket lists a set of game modes that a player is willing to play. The system can match the player into any of these game modes. Two tickets match if the intersection of their game mode sets is non-empty. Here, the system treats the set of game modes as the ticket's type. If there are N game modes, then there will be 2^{N}-1 ticket types, since the empty set is excluded. Consequently, the system can perform optimal matchmaking among ticket types based on preferred game modes.

Because the utility function is linear, new metrics can be added and considered when establishing the optimal transformation used to produce matches. For example, consider a scenario where each created match has an associated datacenter (e.g., server) hosting the match (e.g., the multiplayer session). The associated datacenter can be selected from a finite set of datacenter configured at different geographic locations (e.g., a game title may have one datacenter in England, one datacenter in Australia, two datacenter in the United States, etc.). Each player has a known latency to each datacenter, and these known latencies can be reflected in a latency table. The latency table can be provided by a player's client device via a submission of a ticket (e.g., 100 ms latency to Server A, 50 ms latency to Server B, etc.). Consequently, the system is made aware of a player's and/or client device's latency to any given datacenter.

The system may have a desire to trade-off latency with the other metrics such as wait time, predictability, etc. Accordingly, the utility function can include a latency metric. In one implementation, latency can be defined as the average, for players in a match, of the latency between an individual player and a datacenter chosen to host the match. The desired trade-off that accounts for latency can then be expressed in the utility function using a new weight called Latency Weight. An example utility function using latency may be defined as follows:
utility=−waitTime−Latency Weight*latency+(other metrics)

The acceptance region of a ticket now depends on its skill rating, its latency information, and the latency information of another ticket. Let [L(S,A,B),R(S,A,B)] denote the range of skill ratings on a ticket with latency table B that are acceptable to a ticket with latency table A and skill rating S. To represent the case where the datacenter is unacceptable regardless of skill rating, we allow L>R. This problem can be solved by treating each distinct latency table as a ticket type and computing a skill transformation for every possible pair of types.

To make the computation more straightforward, latencies can be quantized into a small number of buckets based on geographic regions where a group of players are located. Stated another way, players in a same geographic region have the same latency value (e.g., the same latency table) to each of multiple datacenters that are capable of hosting a multiplayer session.

To summarize, the acceptance region of a ticket becomes [L(S,A,B),R(S,A,B)] where A is the transformed latency table of the ticket and B is the datacenter that would be chosen for the match. This acceptance region corresponds to a threshold of one in a transformed skill space where the transformation depends on A and B. The system can monitor matching statistics sufficient to obtain the ticket arrival rate and the skill rating distribution of tickets that would use datacenter B when matched with a ticket whose transformed latency table is A, for all (A,B). Each transformation can be approximated by scaling the cumulative skill rating distribution.

In additional implementations, a player may want to play with a friend, and thus, multiple people make one ticket, which may be referred to as a squad ticket. Accordingly, a squad consists of multiple players who must play in the same match on the same team. Suppose each player has their own latency table. According to the definition of the latency metric, the contribution of a squad to the latency metric is the average latency of any member of the squad to a chosen datacenter. This metric is unchanged if it is assumed that every member of the squad has the same latency table, equal to the average of their latency tables. Since latency tables are quantized into ticket types, the ticket type whose latency table is closest to the average can be picked. Similarly, the predictability metric is unchanged if it is assumed that every member of the squad has the same skill rating, equal to the average of their skill ratings. Therefore, a squad ticket can be represented by the ticket type closest to the average latency table, an average skill rating, and the number of players in the squad.

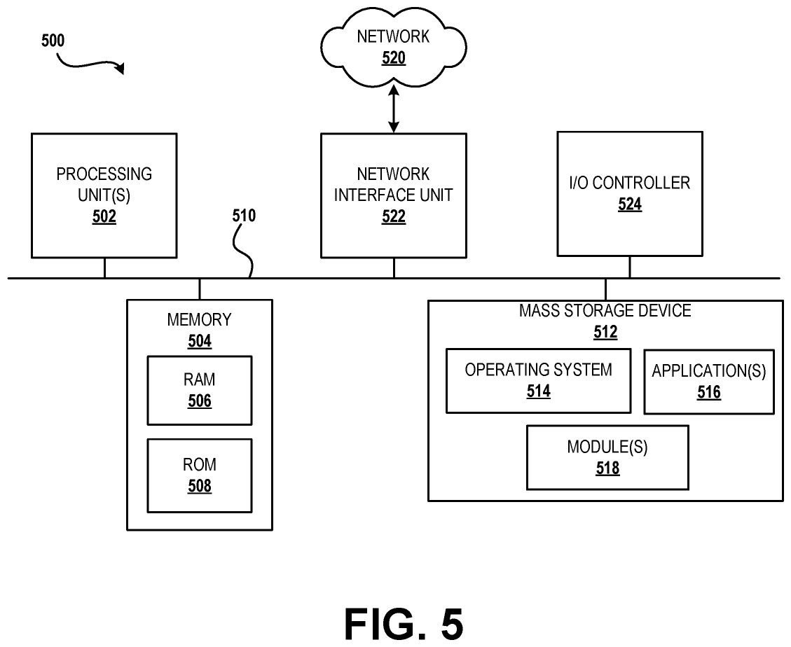

FIG. 5 shows additional details of an example computer architecture 500 for a computer, such as one of the client devices 104 or a server configured as part of the matchmaking system 102, capable of executing computer instructions (e.g., a module or a program component described herein). The computer architecture 500 illustrated in FIG. 5 includes processing unit(s) 502, a system memory 504, including a random access memory 506 (“RAM”) and a read-only memory (“ROM”) 508, and a system bus 510 that couples the memory 504 to the processing unit(s) 502.

Processing unit(s), such as processing unit(s) 502, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518 (e.g., the skill rating transformation module 118 and the matching module 120), and other data described herein.

The mass storage device 512 is connected to processing unit(s) 502 through a mass storage controller connected to the bus 510. The mass storage device 512 and its associated computer-readable media provide non-volatile storage for the computer architecture 500. Although the description of computer-readable media contained herein refers to a mass storage device, it should be appreciated by those skilled in the art that computer-readable media can be any available computer-readable storage media or communication media that can be accessed by the computer architecture 500.

Computer-readable media can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

It should be appreciated that the software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein. These computer-executable instructions may transform the processing unit(s) 502 by specifying how the processing unit(s) 502 transition between states, thereby transforming the transistors or other discrete hardware elements constituting the processing unit(s) 502.

The disclosure presented herein also encompasses the subject matter set forth in the following clauses.

Example Clause A, a method comprising: determining an estimated arrival rate of matchmaking requests useable to establish a multiplayer session, wherein an individual matchmaking request comprises a skill rating for a player; determining an estimated skill rating distribution for the matchmaking requests; determining, by one or more processing units, a function that defines a skill rating transformation based at least in part on the estimated arrival rate of the matchmaking requests and the estimated skill rating distribution for the matchmaking requests; receiving a matchmaking request that includes a skill rating in a first skill rating space; using the function to transform the skill rating included in the received matchmaking request into a transformed skill rating in a second skill rating space; and matching the received matchmaking request with at least one other matchmaking request using the transformed skill rating.

Example Clause B, the method of Example Clause A, wherein the function is determined using a utility function that includes: an expected wait time metric computed using the estimated arrival rate of the matchmaking requests and the estimated skill rating distribution for the matchmaking requests; an expected skill rating gap metric computed using the estimated skill rating distribution for the matchmaking requests; and an expected win rate difference metric computed using the estimated skill rating distribution for the matchmaking requests.

Example Clause C, the method of Example Clause B, wherein the utility function is configured to: evaluate a plurality of functions based on the expected wait time metric, the expected skill rating gap metric, and the expected win rate difference metric associated with each function of the plurality of functions; and select the function used to transform the skill rating from the plurality of functions based on an evaluation that indicates maximum utility.

Example Clause D, the method of Example Clause B or Example Clause C, wherein each of the expected skill rating gap metric and the expected win rate difference metric is associated with a corresponding weight configured to be set by a game title that hosts the multiplayer session.

Example Clause E, the method of any one of Example Clauses B through D, wherein the utility function further includes a latency metric.

Example Clause F, the method of any one of Example Clauses A through E, further comprising: updating, based on a predetermined time interval, the estimated arrival rate of the matchmaking requests and the estimated skill rating distribution for the matchmaking requests; and rescaling the function that defines the skill rating transformation based at least in part on the updated estimated arrival rate of the matchmaking requests and the updated estimated skill rating distribution for the matchmaking requests.

Example Clause G, the method of any one of Example Clauses A through F, wherein transforming the skill rating included in the received matchmaking request into the transformed skill rating defines an acceptance region that represents possible skill ratings that the received matchmaking request will accept to enable the matchmaking of the matchmaking request with the at least one other matchmaking request.

Example Clause H, the method of Example Clause G, wherein transforming the skill rating included in the received matchmaking request into the transformed skill rating uses a reciprocity constraint to define the acceptance region.

Example Clause I, the method of Example Clause G or Example Clause H, wherein the acceptance region has a fixed interval width that is centered around the transformed skill rating.

Example Clause J, the method of any one of Example Clauses A through I, wherein the estimated arrival rate of the matchmaking requests and the estimated skill rating distribution for the matchmaking requests are specific to a particular type of matchmaking request of a plurality of different types of matchmaking requests, wherein the particular type of matchmaking request is specified in the received matchmaking request.

Example Clause K, the method of Example Clause J, wherein the plurality of different types of matchmaking requests comprise different game modes.

Example Clause L, the method of Example Clause J, wherein the plurality of different types of matchmaking requests comprise different geographic regions established based on latency.

Example Clause M, a system comprising: one or more processing units; and a computer-readable medium having encoded thereon computer-executable instructions to configure the one or more processing units to: determine an estimated arrival rate of matchmaking requests useable to establish a multiplayer session, wherein an individual matchmaking request comprises a skill rating for a player; determine an estimated skill rating distribution for the matchmaking requests; determine a function that defines a skill rating transformation based at least in part on the estimated arrival rate of the matchmaking requests and the estimated skill rating distribution for the matchmaking requests; receive a matchmaking request that includes a skill rating in a first skill rating space; use the function to transform the skill rating included in the received matchmaking request into a transformed skill rating in a second skill rating space; and match the received matchmaking request with at least one other matchmaking request using the transformed skill rating.

Example Clause N, the system of Example Clause M, wherein the function is determined using a utility function configured to: evaluate each of a plurality of functions based on an expected wait time metric computed using the estimated arrival rate of the matchmaking requests and the estimated skill rating distribution for the matchmaking requests, an expected skill rating gap metric computed using the estimated skill rating distribution for the matchmaking requests, and the expected win rate difference metric computed using the estimated skill rating distribution for the matchmaking requests; and select the function used to transform the skill rating from the plurality of functions based on an evaluation that indicates maximum utility.

Example Clause O, the system of Example Clause M or Example Clause N, wherein the computer-executable instructions further configure the one or more processing units to: update, based on a predetermined time interval, the estimated arrival rate of the matchmaking requests and the estimated skill rating distribution for the matchmaking requests; and rescale the function that defines the skill rating transformation based at least in part on the updated estimated arrival rate of the matchmaking requests and the updated estimated skill rating distribution for the matchmaking requests.

Example Clause P, the system of any one of Example Clauses M through 0O, wherein transforming the skill rating included in the received matchmaking request into the transformed skill rating defines an acceptance region that represents possible skill ratings that the received matchmaking request will accept to enable the matchmaking of the matchmaking request with the at least one other matchmaking request, wherein the acceptance region has a fixed interval width that is centered around the transformed skill rating.

Example Clause Q, the system of Example Clause P, wherein transforming the skill rating included in the received matchmaking request into the transformed skill rating uses a reciprocity constraint to define the acceptance region.

Example Clause R, the system of any one of Example Clauses M through Q, wherein the estimated arrival rate of the matchmaking requests and the estimated skill rating distribution for the matchmaking requests are specific to a particular type of matchmaking request of a plurality of different types of matchmaking requests, wherein the particular type of matchmaking request is specified in the received matchmaking request.

Example Clause S, the system of Example Clause R, wherein the plurality of different types of matchmaking requests comprise at least one of different game modes or different geographic regions established based on latency.

Example Clause T, a system comprising: one or processing units; and a computer-readable medium having encoded thereon computer-executable instructions to configure the one or more processing units to: determine an estimated arrival rate of matchmaking requests useable to match players; determine an estimated skill rating distribution for the matchmaking requests; receive a matchmaking request that includes a skill rating in a first skill rating space; apply a function to the skill rating in the first skill rating space, wherein the function transforms the skill rating in the first skill rating space into a transformed skill rating in a second skill rating space and the function learns an acceptance region for the transformed skill rating based at least in part based on the estimated arrival rate of the matchmaking requests and the estimated skill rating distribution for the matchmaking requests; and match the received matchmaking request with at least one other matchmaking request using the transformed skill rating and the acceptance region.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

It should be appreciated that any reference to “first,” “second,” etc. users or other elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different users, two different skill rating spaces, etc.).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. All examples are provided for illustrative purposes and is not to be construed as limiting.

What is claimed is:

1. A method comprising:
determining an estimated arrival rate of matchmaking requests useable to establish a multiplayer session, wherein an individual matchmaking request comprises a skill rating for a player;
determining an estimated skill rating distribution for the matchmaking requests;
determining, by one or more processing units, a function that defines a skill rating transformation based at least in part on the estimated arrival rate of the matchmaking requests and the estimated skill rating distribution for the matchmaking requests;
receiving a matchmaking request that includes a skill rating in a first skill rating space;
using the function to transform the skill rating included in the received matchmaking request into a transformed skill rating in a second skill rating space; and
matching the received matchmaking request with at least one other matchmaking request using the transformed skill rating.

2. The method of claim 1, wherein the function is determined using a utility function that includes:
an expected wait time metric computed using the estimated arrival rate of the matchmaking requests and the estimated skill rating distribution for the matchmaking requests;
an expected skill rating gap metric computed using the estimated skill rating distribution for the matchmaking requests; and
an expected win rate difference metric computed using the estimated skill rating distribution for the matchmaking requests.

3. The method of claim 2, wherein the utility function is configured to:
evaluate a plurality of functions based on the expected wait time metric, the expected skill rating gap metric, and the expected win rate difference metric associated with each function of the plurality of functions; and
select the function used to transform the skill rating from the plurality of functions based on an evaluation that indicates maximum utility.

4. The method of claim 2, wherein each of the expected skill rating gap metric and the expected win rate difference metric is associated with a corresponding weight configured to be set by a game title that hosts the multiplayer session.

5. The method of claim 2, wherein the utility function further includes a latency metric.

6. The method of claim 1, further comprising:
updating, based on a predetermined time interval, the estimated arrival rate of the matchmaking requests and the estimated skill rating distribution for the matchmaking requests; and
rescaling the function that defines the skill rating transformation based at least in part on the updated estimated arrival rate of the matchmaking requests and the updated estimated skill rating distribution for the matchmaking requests.

7. The method of claim 1, wherein transforming the skill rating included in the received matchmaking request into the transformed skill rating defines an acceptance region that represents possible skill ratings that the received matchmaking request will accept to enable the matchmaking of the matchmaking request with the at least one other matchmaking request.

8. The method of claim 7, wherein transforming the skill rating included in the received matchmaking request into the transformed skill rating uses a reciprocity constraint to define the acceptance region.

9. The method of claim 7, wherein the acceptance region has a fixed interval width that is centered around the transformed skill rating.

10. The method of claim 1, wherein the estimated arrival rate of the matchmaking requests and the estimated skill rating distribution for the matchmaking requests are specific to a particular type of matchmaking request of a plurality of different types of matchmaking requests, wherein the particular type of matchmaking request is specified in the received matchmaking request.

11. The method of claim 10, wherein the plurality of different types of matchmaking requests comprise different game modes.

12. The method of claim 10, wherein the plurality of different types of matchmaking requests comprise different geographic regions established based on latency.

13. A system comprising:
one or more processing units; and
a computer-readable medium having encoded thereon computer-executable instructions to configure the one or more processing units to:
determine an estimated arrival rate of matchmaking requests useable to establish a multiplayer session, wherein an individual matchmaking request comprises a skill rating for a player;
determine an estimated skill rating distribution for the matchmaking requests;
determine a function that defines a skill rating transformation based at least in part on the estimated arrival rate of the matchmaking requests and the estimated skill rating distribution for the matchmaking requests;
receive a matchmaking request that includes a skill rating in a first skill rating space;
use the function to transform the skill rating included in the received matchmaking request into a transformed skill rating in a second skill rating space; and
match the received matchmaking request with at least one other matchmaking request using the transformed skill rating.

14. The system of claim 13, wherein the function is determined using a utility function configured to:
evaluate each of a plurality of functions based on an expected wait time metric computed using the estimated arrival rate of the matchmaking requests and the estimated skill rating distribution for the matchmaking requests, an expected skill rating gap metric computed using the estimated skill rating distribution for the matchmaking requests, and the expected win rate difference metric computed using the estimated skill rating distribution for the matchmaking requests; and
select the function used to transform the skill rating from the plurality of functions based on an evaluation that indicates maximum utility.

15. The system of claim 13, wherein the computer-executable instructions further configure the one or more processing units to:
update, based on a predetermined time interval, the estimated arrival rate of the matchmaking requests and the estimated skill rating distribution for the matchmaking requests; and
rescale the function that defines the skill rating transformation based at least in part on the updated estimated arrival rate of the matchmaking requests and the updated estimated skill rating distribution for the matchmaking requests.

16. The system of claim 13, wherein transforming the skill rating included in the received matchmaking request into the transformed skill rating defines an acceptance region that represents possible skill ratings that the received matchmaking request will accept to enable the matchmaking of the matchmaking request with the at least one other matchmaking request, wherein the acceptance region has a fixed interval width that is centered around the transformed skill rating.

17. The system of claim 16, wherein transforming the skill rating included in the received matchmaking request into the transformed skill rating uses a reciprocity constraint to define the acceptance region.

18. The system of claim 13, wherein the estimated arrival rate of the matchmaking requests and the estimated skill rating distribution for the matchmaking requests are specific to a particular type of matchmaking request of a plurality of different types of matchmaking requests, wherein the particular type of matchmaking request is specified in the received matchmaking request.

19. The system of claim 18, wherein the plurality of different types of matchmaking requests comprise at least one of different game modes or different geographic regions established based on latency.

20. A system comprising:
one or processing units; and
a computer-readable medium having encoded thereon computer-executable instructions to configure the one or more processing units to:
determine an estimated arrival rate of matchmaking requests useable to match players;
determine an estimated skill rating distribution for the matchmaking requests;
receive a matchmaking request that includes a skill rating in a first skill rating space;
apply a function to the skill rating in the first skill rating space, wherein the function transforms the skill rating in the first skill rating space into a transformed skill rating in a second skill rating space and the function learns an acceptance region for the transformed skill rating based at least in part based on the estimated arrival rate of the matchmaking requests and the estimated skill rating distribution for the matchmaking requests; and
match the received matchmaking request with at least one other matchmaking request using the transformed skill rating and the acceptance region.
